(19) United States
(12) Patent Application Publication
(10) Pub. No.: US 2016/0157090 A1
(43) Pub. Date: Jun. 2, 2016

(54) Connection Method and Communication Device for Electronic Systems

(71) Applicants: Inventec (Pudong) Technology Corp., Shanghai (CN); Inventec Corporation, Taipei (TW)

(72) Inventors: Chien-Yao Huang, Taipei (TW); Hsien-Jung Hsu, Taipei (TW)

(21) Appl. No.: 14/676,829

(22) Filed: Apr. 2, 2015

(30) Foreign Application Priority Data
Nov. 28, 2014 (CN) 201410707949.5

(51) Int. Cl. H04W 8/22; H04W 76/02; H04W 40/24; H04W 72/02; H04W 12/08; H04W 4/00

(52) U.S. Cl. CPC H04W 8/22; H04W 12/08; H04W 4/008; H04W 40/24; H04W 72/02; H04W 76/021; H04W 84/18

(57) ABSTRACT

A connection method for an electronic system is disclosed. The electronic system comprises a plurality of communication devices. Each communication device can establish a plurality of wireless connection modes with another communication device. The connection method comprises when a first communication device is instructed to transmit an data-to-be-transmitted to a second communication device, the first communication device determining at least an data property of the data-to-be-transmitted and at least a connection property of the plurality of wireless connection modes in relation to the second communication device; and the first communication device selecting a wireless connection mode from the plurality of wireless connection modes according to the least a data property of the data-to-be-transmitted and the at least a connection property of the plurality of wireless connection modes in relation to the second communication device, so as to transmit the data-to-be-transmitted to the second communication device.

### BACKGROUND OF THE INVENTION

1. Field of the Invention

The present invention relates to a connection method and a communication device, and more particularly, to a connection method and a communication device determining wireless connection modes according to data properties of the data-to-be-transmitted and connection properties of wireless connection modes.

2. Description of the Prior Art

As wireless communication technologies highly develop, various wireless communication products become an essential part of human life. In addition to personal mobile devices such as phones, tablets, notebook, etc., home appliances such as televisions, air conditionings, refrigerators, washing machines, ovens, water heaters, are gradually equipped with wireless network connection functions. These home appliances are called smart home appliances, which may allow users to perform remote control, set appliance configurations, query usage status, etc., through personal mobile devices. However, as a number of the smart home appliance increases, the user may need to connect with multiple smart home appliances at the same time through the personal mobile device. In such a situation, since the smart home appliances are located at different locations in a home residence, the wireless signal qualities to the personal mobile device may be affected by furniture, decorating, partitions, building materials, etc. Only part of the smart home appliances may build normal wireless connections with the personal mobile device, and other smart home appliances may not be able to build wireless connections or only be able to build wireless connections with low data rate. Therefore, the utilization convenience of the smart home appliances is reduced, and even the original functions of the smart home appliances are affected.

Therefore, how to make sure that the smart home appliance can build up connections with the personal mobile device is a significant objective in the field.

### SUMMARY OF THE INVENTION

It is therefore a primary objective of the present invention to provide a connection method utilized in an electronic system and a communication device, capable of selecting wireless connection modes satisfying system requirement according to data properties of the data-to-be-transmitted and connection properties of wireless connection modes.

The present invention discloses a connection method utilized for an electronic system. The electronic system comprises a first communication device and a second communication device, and the first communication device is capable of establishing a plurality of wireless connection modes with the second communication device. The connection method comprises when a first communication device is instructed to transmit a data-to-be-transmitted to a second communication device, the first communication device determining at least a data property of the data-to-be-transmitted and at least a connection property of the plurality of wireless connection modes in relation to the second communication device; and the first communication device selecting a wireless connection mode from the plurality of wireless connection modes according to the least a data property of the data-to-be-transmitted and the at least a connection property of the plurality of wireless connection modes in relation to the second communication device, so as to transmit the data-to-be-transmitted to the second communication device.

The present invention further discloses a communication device, utilized for an electronic system. The communication device comprises a plurality of communication modules, configured to establish a plurality of wireless connection modes; a processor; a storage unit, configured to store a programming code, the programming code instructing the processor to perform following steps when receiving an instruction which instruct the communication device to transmit an data-to-be-transmitted to another communication device of the communication device, determining at least an data property of the data-to-be-transmitted and at least a connection property of the plurality of wireless connection modes in relation to the another communication device; and selecting a wireless connection mode from the plurality of wireless connection modes according to the least a data property of the data-to-be-transmitted and the at least a connection property of the plurality of wireless connection modes in relation to the another communication device, so as to transmit the data-to-be-transmitted to the another communication device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a schematic diagram of an electronic system according to an embodiment of the present invention.

FIG. 1B is a schematic diagram of a communication device of the electronic system in FIG. 1A according to an embodiment of the present invention.

FIG. 2 is a schematic diagram of a connecting process according to an embodiment of the present invention.

FIG. 3 is a schematic diagram of a smart home appliance system according to an embodiment of the present invention.

### DETAILED DESCRIPTION

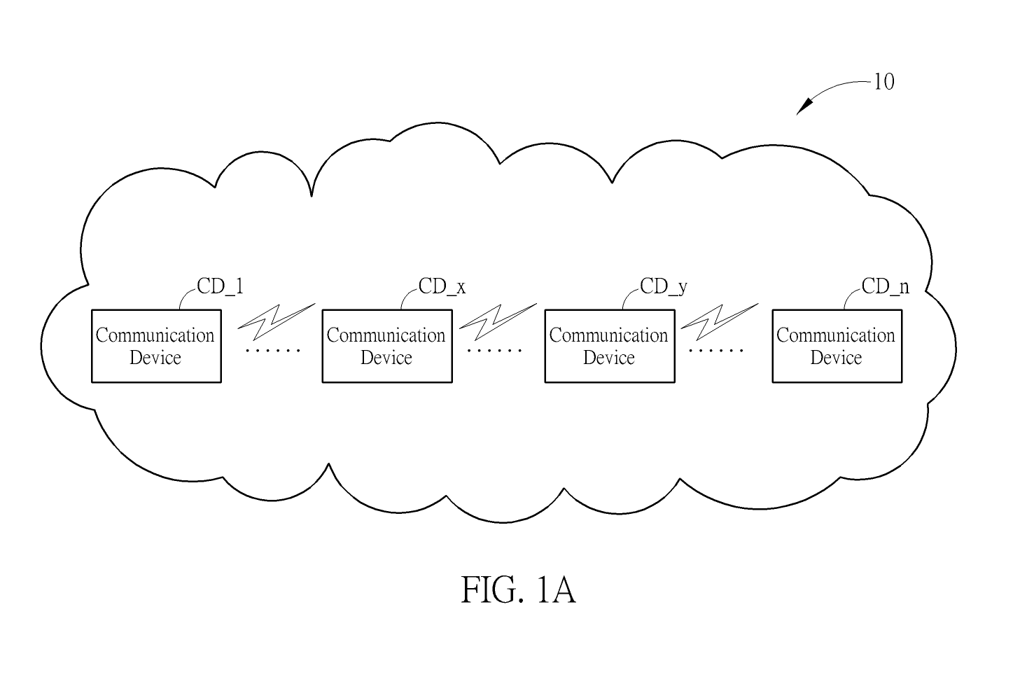

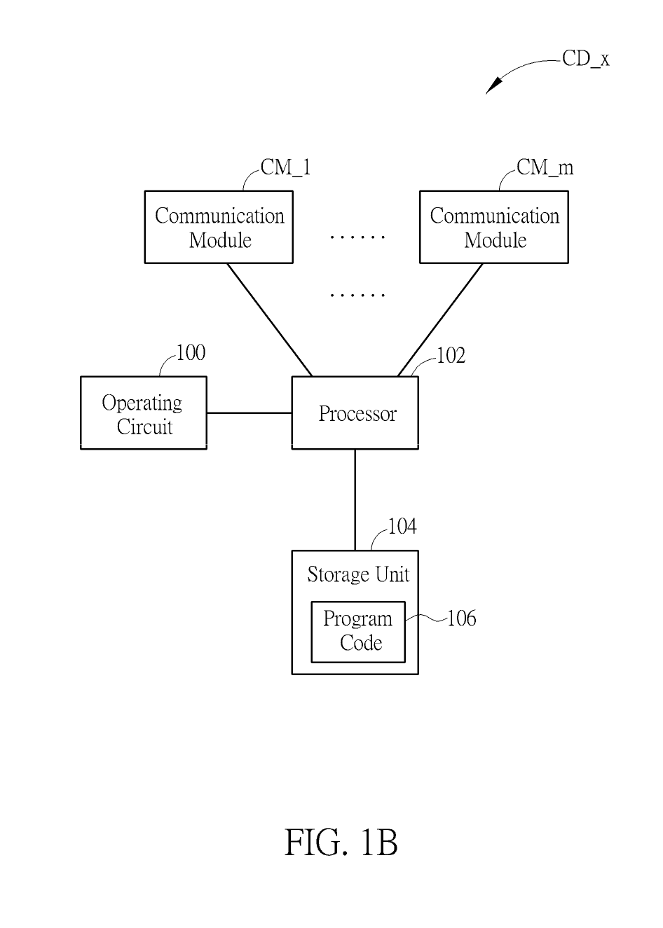

Please refer to FIG. 1A, which is a schematic diagram of an electronic system 10 according to an embodiment of the present invention. The electronic system 10 comprises communication devices CD_1-CD_n. Each of the communication devices CD_1-CD_n may be an electronic product with wireless communication function such as a smart phone, a smart home appliance, etc., which is capable of establishing a plurality of wireless communication connections with another communication device. For clarity, as shown in FIG. 1B, a basic structure of any of the communication devices CD_1-CD_n, say CD_x, comprises an operating circuit 100, communication modules CM_1-CM_m, a processor 102 and a storage unit 104. Moreover, the operating circuit 100 may have different structures corresponding to different applications. For example, the operating circuit 100 of a smart phone may comprise a touch screen, a speaker, a microphone, a rechargeable battery, etc. The operating circuit 100 of a smart refrigerator may comprise power transformer, compressor, etc. In addition, the number “m” of the communication modules CM_1-CM_m is a number of wireless connection modes of the communication device CD_x being able to operate. The wireless connection modes of the communication device CD_x being able to operate may be modified according to system requirements. For example, the wireless connection modes maybe selected from wireless personal area network (WPAN) modes, bluetooth (BT) modes, wireless local network (WLAN) modes, wireless metropolitan area network (WMAN) modes, wireless wide area network (WWAN) modes, wireless fidelity (Wi-Fi) modes, worldwide interoperability for microwave access (WiMAX) modes, long term evolution (LTE) modes, etc., and not limited herein.

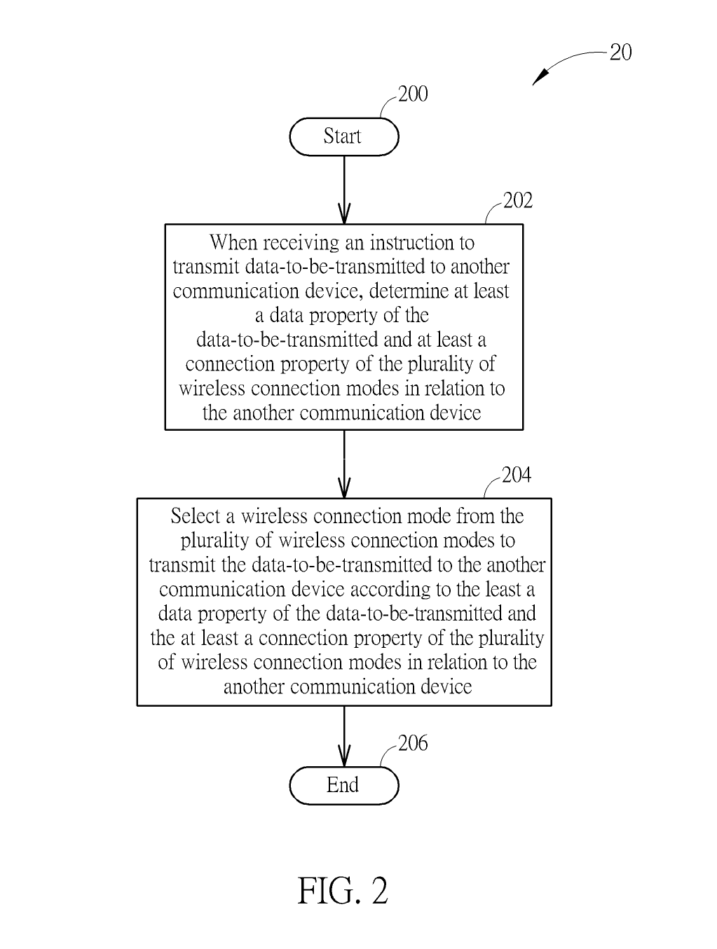

In another perspective, the communication device CD_x may establish a plurality of wireless connection modes with another communication device; in addition, the communication device CD_x may select an appropriate connection mode to perform data transmission according to data properties of data-to-be-transmitted and connection properties of the wireless connection modes. Related operations thereof may be referred to FIG. 2, which is a schematic diagram of a connecting process 20 according to an embodiment of the present invention. The connecting process 20 may be applied to each of the communication devices CD_1-CD_n, and compiled as a program code 106 stored in the storage unit 104. The connecting process 20 comprises following steps:

Step 200: Start.

Step 202: When receiving an instruction to transmit data-to-be-transmitted to another communication device, determine at least a data property of the data-to-be-transmitted and at least a connection property of the plurality of wireless connection modes in relation to the another communication device.

Step 204: Select a wireless connection mode from the plurality of wireless connection modes to transmit the data-to-be-transmitted to the another communication device according to the least a data property of the data-to-be-transmitted and the at least a connection property of the plurality of wireless connection modes in relation to the another communication device.

Step 206: End.

According to the connecting process 20, when an communication device of the communication devices CD_1-CD_n (e.g., the communication device CD_x) receives an instruction to transmit data-to-be-transmitted to another communication device (e.g., the communication device CD_y), the communication device CD_x determines the data properties of the data-to-be-transmitted and the connection properties of all of the wireless connection modes in relation to the communication device CD_y, and selects a communication module from the communication modules CM_1-CM_m accordingly to transmit the data-to-be-transmitted to the communication device CD_y. In other words, the communication device CD_x may dynamically and automatically select an appropriate communication module to transmit data to the communication device CD_y, according to the data properties (such as data amount, safety requirement, urgency, etc.) and the connection properties of the wireless connections (such as transmission capacity, re-transmission mechanism, encryption/decryption mechanism, etc.). Thus, data is guaranteed to be transmitted to the communication device CD_y correctly and efficiently.

For example, when a data amount of the data-to-be-transmitted is large or transmission of the data-to-be-transmitted needs to be completed in a short time, the communication device CD_x may select a wireless connection mode with larger transmission capacity, and activate the corresponding communication module to perform data transmission. When a safety requirement of the data-to-be-transmitted is high, or the data-to-be-transmitted needs to be protected during transmission, the communication device CD_x may select a wireless connection mode with a higher degree of information protection, and activate the corresponding communication module to perform data transmission. Therefore, the communication device CD_x guarantees that the data is correctly and efficiently transmitted to the communication device CD_y.

Notably, the connecting process 20 is an embodiment of the present invention. Those skilled in the art may make modifications and alternations accordingly, and not limited herein. For example, according to Step 202, the communication device CD_x determines the data properties of the data-to-be-transmitted. Methods of determining the data properties may be modified according to system architecture and requirements. In an embodiment, if the data-to-be-transmitted comprises a safety flag, a safety requirement of the data-to-be-transmitted may be determined according to the safety flag. On the other hand, if the data-to-be-transmitted do not comprise the safety flag, the safety requirement of the data-to-be-transmitted may be determined according to a packet type. Generally, acknowledgement packets have lower safety requirement, data packets have higher safety requirement, and private key packets or secret key packets have the highest safety requirement. In another perspective, if the data-to-be-transmitted comprises a data amount field, a data amount of the data-to-be-transmitted may be determined according to the data amount field. On the other hand, if the data-to-be-transmitted do not comprise a data amount field, the data amount of the data-to-be-transmitted may be directly calculated. In addition, if contents of the data-to-be-transmitted are packet information generated by instant communication applications such as voice over IP (VoIP), an urgency of the data-to-be-transmitted is high, which need to be transmitted as soon as possible.

In addition, according to Step 202, the communication device CD_x has to determine connection properties, such as connection qualities, connection securities, etc., of the connection modes in relation to the communication device CD_y, and not limited herein. Generally, the connection qualities of the connection modes may be determined by transmission capacities and signal qualities of the wireless connection modes. Methods of determining the connection properties may be modified according to system architecture and requirements. For example, in an embodiment, the communication device CD_x may send testing packets through the communication modules CM_1-CM_m to the communication device CD_y, so as to determine an achievable transmission capacity or signal quality of each of the communication modules CM_1-CM_m. In another embodiment, determination results of the connection qualities may be stored as a reference for later on transmission. In another embodiment, a priority order of using the communication modules CM_1-CM_m may be specified by user. In another perspective, the connection securities may be determined by whether the data-to-be-transmitted is able to be encrypted, or by transmission ranges of the wireless connection modes. For example, a wireless connection mode with a tens-meter transmission range would not be eavesdropped by other communication devices which are out of the tens meters range. Similarly, determination results of the connection securities may be stored in the communication devices CD_1-CD_n as a reference for later on transmission.

After determining the data properties of the data-to-be-transmitted and the connection properties of the wireless connection modes in Step 202, according to Step 204, the communication device CD_x may select a communication module from the communication modules CM_1-CM_m to transmit the data-to-be-transmitted to the another communication device. For example, if the safety requirement of the data-to-be-transmitted is needed to be highly protected or the safety requirement is greater than a predefined value, the communication device CD_x may select a communication module capable of executing an information-protecting wireless connection mode (or a wireless connection mode with an information protection degree greater than a predefined degree) to transmit the data-to-be-transmitted. If the data amount of the data-to-be-transmitted is greater than a predefined value, the communication device CD_x may select a communication module capable of executing a wireless connection mode with high transmission capacity (or a wireless connection mode with the transmission capacity greater than a predefined value) to transmit the data-to-be-transmitted.

Furthermore, if the safety requirement or the data amount of the data-to-be-transmitted is not considered, or the safety requirement or the data amount of the data-to-be-transmitted is not greater than the predefine value, or the safety requirement or the data amount of the data-to-be-transmitted fails to be determined, in an embodiment, the communication device CD_x selects a communication with the strongest signal quality to transmit the data-to-be-transmitted. In another perspective, the safety requirement or the data amount of the data-to-be-transmitted stated in the above is only for illustrative purpose, and not limited herein. Those skilled in the art may make modifications and alternations adequately. For example, selecting rules may be defined according to data urgencies, data types, data sources, etc. The wireless connection modes may also be selected according to various data characteristics or weightings configured for different data characteristics. For example, the safety requirement is considered first, the data amount, the urgency, etc., are considered then, which is also within the scope of the present invention. Similarly, the connection properties of the wireless connection modes are not limited to transmission capacities and signal qualities. Other properties, such as operation frequency bands, numbers of channels may also be taken into consideration. Weighting of the connection properties may also be configured.

In another perspective, in the paragraphs stated in the above, the data-to-be-transmitted represents the data of the communication device CD_x instructed to be transmitted to the communication device CD_y. The data-to-be-transmitted may be generated by the processor 102 of the communication device CD_x, and the communication device CD_x is instructed by a user to transmit the data-to-be-transmitted to the communication device CD_y. The data-to-be-transmitted may also be generated by the processor 102 of the communication device CD_x, and the communication device CD_x is instructed by a user through internet to transmit the data-to-be-transmitted to the communication device CD_y. The data-to-be-transmitted may also be generated by communication devices other than the communication devices CD_x and CD_y, which is transmitted to the communication device CD_x, and the processor 102 of the communication device CD_x is instructed to transmit the data-to-be-transmitted to the communication device CD_y. No matter how the data-to-be-transmitted is generated, a primary objective of the present invention is to select the proper wireless connection mode and the corresponding communication module, according to the data properties of the data-to-be-transmitted, to perform data transmission. Modifications and alternations thereof are within the scope of the present invention.

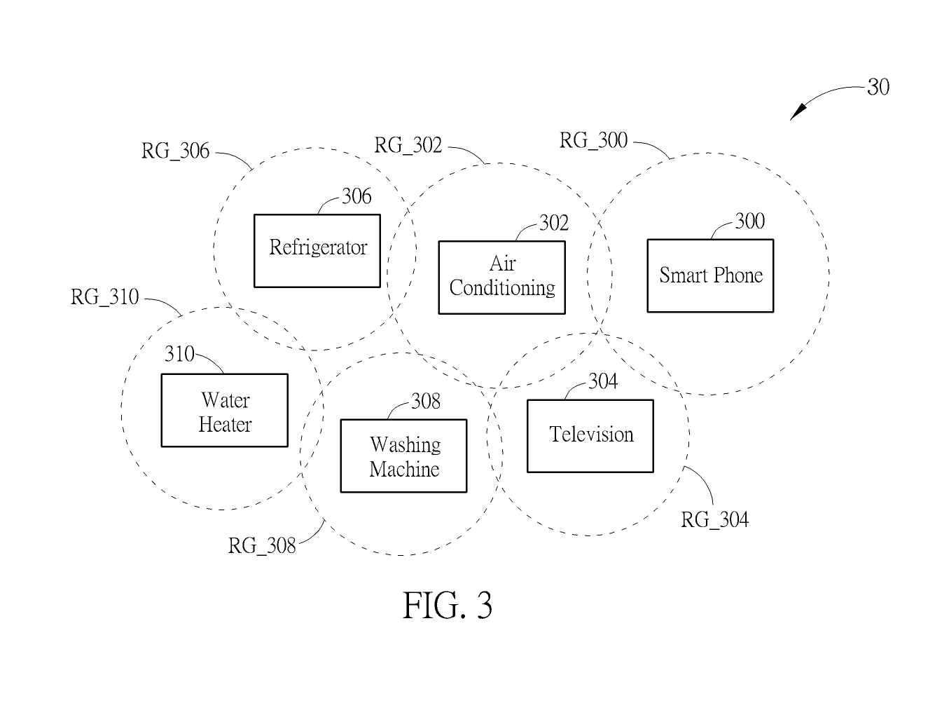

For example, if the electronic system 10 is a realization of a smart home appliance system, the communication devices CD_1-CD_n may represent smart home appliances or personal mobile devices. In other words, when the smart home appliances and the personal mobile devices perform communications, according to the present invention, the smart home appliances may select a proper wireless connection mode to perform data transmission according to data properties, to make sure that the data is transmitted to the personal mobile devices correctly and efficiently. For example, please refer to FIG. 3, which is a schematic diagram of a smart home appliance system 30 according to an embodiment of the present invention. The smart home appliance system 30 is designed according to the electronic system 10, which is deployed in a home residence. The smart home appliance system 30 comprises a smart phone 300, an air conditioning 302, a television 304, a refrigerator 306, a washing machine 308 and a water heater 310. The air conditioning 302, the television 304, the refrigerator 306, the washing machine 308 and the water heater 310 are all smart home appliances, which have wireless network connection functions, such that a user may remotely control the smart home appliances, set the configuration of the smart home appliances, query usage statuses of the smart home appliances, etc., through the smart phone 300. In addition, to explain easily, FIG. 3 illustrates communication ranges of the devices. For example, RG_300, RG_302, RG_304, RG_306, RG_308, RG 310 respectively represent signal ranges of the smart phone 300, the air conditioning 302, the television 304, the refrigerator 306, the washing machine 308 and the water heater 310. Notably, the signal ranges RG_300-RG_310 only represent signal conditions in a specific scenario or in a specific mode. When two of the signal ranges overlaps, the corresponding devices may perform wireless communication. For example, the smart phone 300 may connect with the air conditioning 302 and the television 304 through the signal ranges RG_300, RG_302 and RG 304. Furthermore, in this example, the signal ranges RG_302-RG_310 represent the farthest communication ranges of the smart home appliances. In other words, the air conditioning 302, the television 304, the refrigerator 306, the washing machine 308 and the water heater 310 may be equipped with multiple communication modules to communicate indifferent connection modes, and the farthest communication ranges of the equipped communication modules are represented by RG_302-RG_310.

Since the smart home appliance system 30 is designed according to the electronic system 10, the smart home appliance system 30 may select an appropriate communication module to perform data transmission according to the data properties of the data-to-be-transmitted and connection properties of the wireless connection modes. Explanation is provided by following embodiments. In an embodiment, if the smart phone 300 needs to transmit a control signal to the air conditioning 302, the smart phone 300 may send an instruction directly through the signal ranges RG_300, RG_302 to the air conditioning 302. If the control signal is a low safety required data such as a temperature control or an air weight control, the smart phone 300 may select a communication module with the strongest signal quality to transmit the data-to-be-transmitted. In an embodiment, if the smart phone 300 needs to control the television 304 to perform high safety requirement operations such as firmware update, web browsing, etc., the smart phone 300 may select a communication module capable of performing information protection to transmit the control instruction. In an embodiment, if the smart phone 300 needs to perform instant operations with large data amount through the television 304 such as wireless display, video conference call, etc., the smart phone 300 may select a communication module capable of performing instant operations with large data rate to perform the wireless connection.

Furthermore, if the refrigerator 306 needs to transmit operation information to the smart phone 300, since the signal range RG 306 of the refrigerator 306 does not overlap with the signal range RG 300 of the smart phone 300, i.e., no direct connection exists between these two, nevertheless, according to the present invention, the refrigerator 306 may build a connection with the air conditioning 302 through the signal ranges RG_306, RG_302, and after the air conditioning 302 received the data to be transmitted to the smart phone 300, the air conditioning 302 may further transmit the data from the refrigerator 306 to the smart phone 300 through the signal ranges RG_302, RG_300. Similarly, if the smart phone 300 and the water heater 310 have needs for data transmission in between (either from the smart phone 300 to the water heater 310, or from the water heater 310 to the smart phone 300) , even though there is no direct connection path between the smart phone 300 and the water heater 310, according to the present invention, the smart phone 300 and the water heater 310 may build up an indirect wireless connection through the air conditioning 302 and the refrigerator 306 (i.e., through the signal ranges RG_302, RG_306), or through the television 304 and the washing machine 308 (i.e., through the signal ranges RG_304, RG_308). Therefore, whether the smart phone 300 can have direct connections with the smart appliances or not, according to the present invention, the smart phone 300 is able to build an information exchange channel with the smart appliances.

Furthermore, in addition to the user connecting to the smart appliance through the smart phone 300, the user may connect to the smart appliance by using internet to instruct the smart phone 300 to perform data transmission. In an embodiment, if the user is out of the home residence but needs to access a food ingredient list stored in the refrigerator 306, the user may (for example use a computer to) instruct the refrigerator 306 to send back the food ingredient list through internet, or instruct the smart phone 300 to connect to the refrigerator 306 through the air conditioning 302 (i.e., through the signal ranges RG_300, RG_302, RG_306), such that the refrigerator 306 may send the food ingredient list through the wireless connections to the smart phone 300, and the smart phone 300 may send the food ingredient list through internet to the user who is out of the home residence. Therefore, whether the location of the user is in the home residence or not, according to the present invention, the user may directly instruct or indirectly instruct the smart phone 300 through internet to exchange data with the smart home appliances.

As can be seen form the above, according to the present invention, the smart home appliances may adequately modify the data transmission connections, to make sure that the data is correctly transmitted, so as to enhance the utilization convenience of the smart home appliance. In comparison, in the prior art, the smart home appliances may not connect with the personal mobile device, such that the utilization convenience of the smart home appliance is reduced and even the original functions of the smart home appliances are affected.

In summary, according to the present invention, the smart home appliances and the personal mobile device may directly or indirectly establish the wireless connections, regardless of the locations of the smart home appliances, the partitions in the home residence, etc. Meanwhile, the connection modes between the smart home appliances and the personal mobile devices may be properly selected according to the data properties of the data-to-be-transmitted and the connection properties of the wireless connection modes. Therefore, the utilization convenience of the smart home appliances is enhanced, and the smart home appliances function even more effectively.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A connection method utilized for an electronic system, the electronic system comprising a first communication device and a second communication device, the first communication device being capable of establishing a plurality of wireless connection modes with the second communication device, the connection method comprising:
when a first communication device is instructed to transmit a data-to-be-transmitted to a second communication device, the first communication device determining at least a data property of the data-to-be-transmitted and at least a connection property of the plurality of wireless connection modes in relation to the second communication device; and
the first communication device selecting a wireless connection mode from the plurality of wireless connection modes according to the least a data property of the data-to-be-transmitted and the at least a connection property of the plurality of wireless connection modes in relation to the second communication device, so as to transmit the data-to-be-transmitted to the second communication device.

2. The connection method of claim 1, wherein the least a data property comprises a safety flag and a data amount of the data-to-be-transmitted, the at least a connection property comprises connection qualities and securities of the plurality of wireless connection modes, the connection qualities of the plurality of wireless connection modes are determined by transmission capacities and signal qualities of the plurality of wireless connection modes, and the securities of the plurality of wireless connection modes are determined by degrees of information protection of the plurality of wireless connection modes.

3. The connection method of claim 2, wherein when the safety flag indicates that a safety degree of the data-to-be-transmitted is greater than a predefined degree, the first communication device selects the wireless connection mode with a degree of information protection greater than a predefined degree from the plurality of wireless connection modes, to transmit the data-to-be-transmitted to the second communication device.

4. The connection method of claim 2, wherein when the data amount of the data-to-be-transmitted is greater than a predefined value, the first communication device selects the wireless connection mode with a transmission capacity greater than a predefined value from the plurality of wireless connection modes, to transmit the data-to-be-transmitted to the second communication device.

5. The connection method of claim 2, wherein when a safety degree of the data-to-be-transmitted is not greater than a predefined degree and the data amount of the data-to-be-transmitted is not greater than a predefined value, the first communication device selects the wireless connection mode with a strongest signal strength from the plurality of wireless connection modes, to transmit the data-to-be-transmitted to the second communication device.

6. The connection method of claim 1, wherein the data-to-be-transmitted is generated by the first communication device, which is instructed by a user to send the data-to-be-transmitted to the second communication device.

7. The connection method of claim 1, wherein the data-to-be-transmitted is generated by the first communication device, which is instructed by a user through internet to send the data-to-be-transmitted to the second communication device.

8. The connection method of claim 1, wherein the data-to-be-transmitted is generated by a third communication device and sent to the first communication device, and the first communication device is instructed by the third communication device to send the data-to-be-transmitted to the second communication device.

9. The connection method of claim 1, wherein the plurality of wireless connection modes are selected from a wireless personal area network (WPAN) mode, a bluetooth (BT) mode, a wireless local network (WLAN) mode, a wireless metropolitan area network (WMAN) mode, a wireless wide area network (WWAN) mode, a wireless fidelity (Wi-Fi) mode, a worldwide interoperability for microwave access (WiMAX) mode and a long term evolution (LTE) mode.

10. A communication device, utilized for an electronic system, the communication device comprising:
a plurality of communication modules, configured to establish a plurality of wireless connection modes;
a processor;
a storage unit, configured to store a programming code, the programming code instructing the processor to perform following steps:
when receiving an instruction which instruct the communication device to transmit an data-to-be-transmitted to another communication device of the communication device, determining at least an data property of the data-to-be-transmitted and at least a connection property of the plurality of wireless connection modes in relation to the another communication device; and
selecting a wireless connection mode from the plurality of wireless connection modes according to the least a data property of the data-to-be-transmitted and the at least a connection property of the plurality of wireless connection modes in relation to the another communication device, so as to transmit the data-to-be-transmitted to the another communication device.
